(19) United States
(12) Patent Application Publication
(10) Pub. No.: US 2015/0370119 A1
(43) Pub. Date: Dec. 24, 2015

(54) Color Filter Substrate, Liquid Crystal Display Panel, and Liquid Crystal Display Device

(71) Applicant: BOE TECHNOLOGY GROUP CO., LTD., Beijing (CN)

(72) Inventors: Junguo LIU, Beijing (CN); Liqiang YU, Beijing (CN); Yun QIU, Beijing (CN); Hui LI, Beijing (CN); Lingjuan MENG, Beijing (CN)

(21) Appl. No.: 14/550,053

(22) Filed: Nov. 21, 2014

(30) Foreign Application Priority Data
Jun. 23, 2014 (CN) 201410283498.7

(51) Int. Cl. G02F 1/1333; G02B 5/20; G02B 1/14; G02F 1/1335

(52) U.S. Cl. CPC G02F 1/133382; G02F 1/133514; G02B 5/201; G02B 1/14

(57) ABSTRACT

The invention belongs to the filed of display technical, and provides a color filter substrate, a liquid crystal display panel, and a liquid crystal display device, which can solve the problem that the liquid crystal display panel and the liquid crystal display device in the prior art cannot display quickly in low temperatures. Since a heating element is provided on the color filter substrate, the technical solution of the invention has advantages of lower power consumption and more quick heating compared with the external heating manner. Thus, the liquid crystal display panel of the invention can display quickly even when the ambient temperature is too low.

### CROSS-REFERENCE TO RELATED APPLICATION

The present application claims priority based on Chinese Patent Application No. 201410283498.7, the entire content of which is incorporated herein by reference.

### FIELD OF THE INVENTION

The present invention relates to the field of display technology, and particularly to a color filter substrate, a liquid crystal display panel comprising the color filter substrate, and a liquid crystal display device comprising the liquid crystal display panel.

### BACKGROUND OF THE INVENTION

As one of main approaches for acquiring information ultimately during a human-computer interaction, a display is an important component for an information device. On a battlefield, or in a combat commanding, weapon control and information processing system of armed forces, all of large fixed facilities, movement machineries and portable instruments must be provided with a display so as to supply various kinds of information for users. For example, in a cockpit of an aircraft, a pilot may obtain information about over-the-horizon tactical situation, local state, fire control state, navigation, and so on.

A liquid crystal display, the most important one of displays, has an inherent characteristic that the liquid crystal therein will translate into solid state at low temperatures, which causes the liquid crystal display not to display normally at low temperatures. Further, the response speed of the liquid crystal is decreased significantly at low temperatures, and thus the display quality of the liquid crystal display is affected negatively.

In the prior art, an entire display is heated by an external heating manner. For example, the entire display is heated by a resistance-wire meshwork, a layer of electric heating glass added on the display panel thereof, and the like.

The external heating manner mentioned above may increase the total thickness of a liquid crystal display module. In addition, since a heating unit is disposed outside of the liquid crystal cell, heat is conducted into the liquid crystal cell through the air, polarizer sheets, glass and other functional layers (some functional layers have a lower thermal conductivity), thus lots of heat is wasted, which leads to a larger power consumption. Meanwhile, it takes long time for heat to be conducted into the liquid crystal cell through so many functional layers, so that the time for the liquid crystal reaching to its normal working state is too long.

### SUMMARY OF THE INVENTION

In order to solve the problem that the liquid crystal display panel in the prior art cannot display rapidly at low temperatures, an objective of the present invention is to provide a color filter substrate, a liquid crystal display panel and a liquid crystal display panel which will not have their performance reduced at low temperatures.

A technical solution for solving the above mentioned technical problem is a color filter, comprising a light-transmission region and a non-light-transmission region, wherein a transparent heating element is provided in the light-transmission region and/or the non-light-transmission region; and/or a non-transparent heating element is provided in the non-light-transmission region.

Preferably, the transparent heating element is connected to a power supply component; and/or the non-transparent heating element is connected to the power supply component.

Preferably, the transparent heating element is made of transparent metal or alloy, and the non-transparent heating element is made of non-transparent metal or alloy.

Preferably, a projection of the non-transparent heating element on the non-light-transmission region is within the non-light-transmission region.

Preferably, a width of the non-transparent heating element is smaller than 6 μm.

Preferably, the non-transparent heating element or the transparent heating element is formed as a zigzag pattern on the color filter substrate.

Preferably, a protective layer is provided at a side, which is distant away from a substrate of the color filter substrate, of the non-transparent heating element or the transparent heating element.

Another objective of the invention is to provide a liquid crystal display panel, comprising an array substrate, the color filter substrate as mentioned above and a liquid crystal layer disposed between the array substrate and the color filter substrate, wherein the liquid crystal display panel further comprises a first electrode and a second electrode which are disposed on opposite sides of the liquid crystal display panel respectively, the non-transparent heating element or the transparent heating element being electrically connected with the first electrode and the second electrode.

Still another objective of the invention is to provide a temperature control system for liquid crystal display panel, comprising: a temperature sensor for detecting temperature of the liquid crystal display panel and generating a temperature signal; a controller for receiving the temperature signal from the temperature sensor, determining whether a non-transparent heating element or a transparent heating element in the liquid crystal display panel should be powered or not based on the temperature signal, and sending an instruction of supplying power if result of the determination is positive; and a power supply for receiving the instruction of supplying power from the controller, and supplying power to the non-transparent heating element or the transparent heating element in the liquid crystal display panel based on the instruction.

Preferably, the liquid crystal display panel is the above mentioned liquid crystal display panel provided by the present invention.

Still another objective of the invention is to provide a liquid crystal display device comprising the above mentioned color filter substrate.

Still another objective of the invention is to provide a liquid crystal display device comprising the above mentioned liquid crystal display panel.

Preferably, the liquid crystal display device further comprises the above mentioned temperature control system for liquid crystal display panel.

For the color filter substrate, the liquid crystal display panel comprising the color filter substrate, and the liquid crystal display device comprising the liquid crystal display panel in the invention, since a heating element is provided on the color filter substrate, advantages of low power consumption and fast warming are achieved compared to the external heating manner. Thus, the liquid crystal display panel of the invention can display quickly even when the ambient temperature is too low.

### BRIEF DESCRIPTION OF THE DRAWINGS

FIG. 1 is a schematic section view of the color filter substrate in the embodiment 1 of the present invention.

FIG. 2 is a schematic top view of the black matrix and the strip-shaped non-transparent heating element on the color filter substrate in the embodiment 1 of the present invention.

FIG. 3 is a schematic top view of a zigzag pattern of the strip-shaped non-transparent heating element on the color filter substrate in the embodiment 1 of the present invention.

FIG. 4 is a schematic top view of a zigzag pattern with a large span of the strip-shaped non-transparent heating element on the color filter substrate in the embodiment 1 of the present invention.

FIG. 5 is a schematic section view of the transparent heating element disposed as a whole layer in the liquid crystal panel in the embodiment 2 of the present invention.

FIG. 6 is a schematic diagram of the construction of the temperature control system for liquid crystal panel in the embodiment 3 of the present invention.

### REFERENCE NUMERALS

1. substrate; 2. heating element; 21. transparent heating element; 22 non-transparent heating element; 3. protective layer; 4. non-light-transmission region (black matrix); 5. light-transmission region (pixel units); 6. first electrode; 7. second electrode.

### DETAILED DESCRIPTION OF THE EMBODIMENTS

Specific embodiments of the present invention are described below in detail in conjunction with the accompanying drawings in order that a skilled person in the art may fully understand the technical solutions of the invention.

### Embodiment 1

The present embodiment provides a color filter substrate. The color filter substrate comprises a light-transmission region and a non-light-transmission region; a transparent heating element is disposed in the light-transmission region and/or the non-light-transmission region; and/or a non-transparent heating element is disposed in the non-light-transmission region.

Since a heating element is provided on the color filter substrate according to the present invention, proper temperature for the color filter substrate and the surrounding thereof may be ensured. For example, a liquid crystal display panel provided with such color filter substrate has the advantages of lower power consumption and faster heating compared with using the external heating manner. Thus, the liquid crystal display panel of the invention can display quickly even when the ambient temperature is too low.

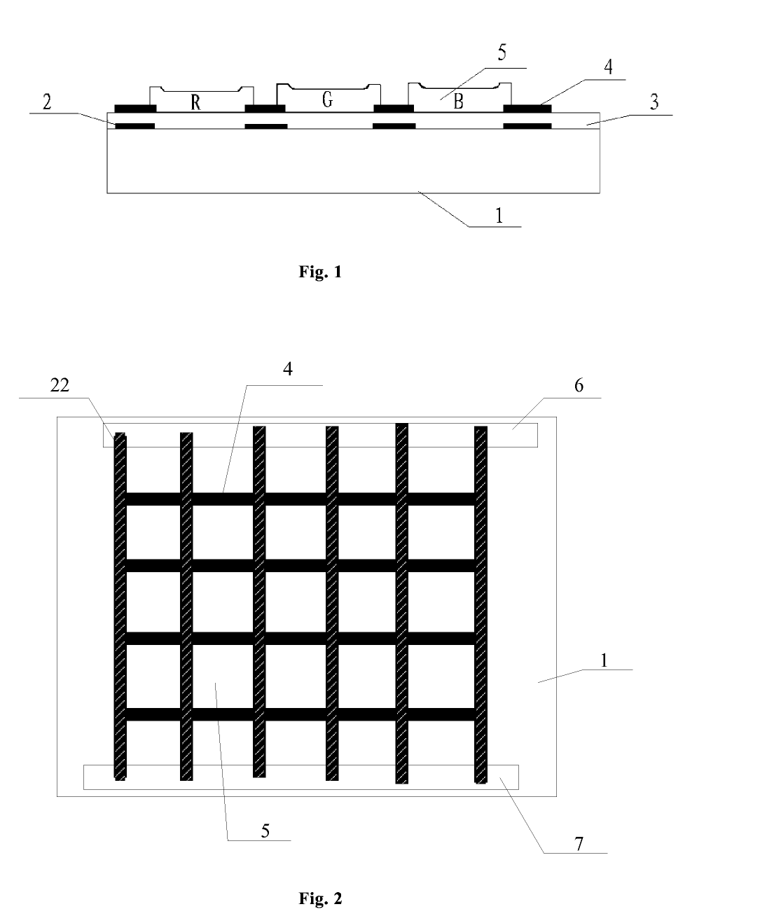

Specifically, as shown in FIG. 1, the color filter substrate comprises a substrate 1, a plurality of pixel units 5 disposed on the substrate 1, and a black matrix 4 disposed among the pixel units 5. The pixel units 5 and the black matrix 4 correspond to the light-transmission region and the non-light-transmission region of the color filter substrate, respectively. The pixel units 5 comprise red pixel units (R), green pixel units (G) and blue pixel units (B). It can be understood that the pixel units may be not limited to these colors, but may be other colors. At one side of the substrate 1 close to the pixel units, there are a heating element 2 disposed thereon for heating the liquid crystal display panel when the temperature of the liquid crystal display panel is too low (especially when the temperature is too low that the display speed of the liquid crystal display panel is affected). Preferably, a protective layer 3 may be provided at one side of the heating element 2 away from the substrate 1 so that the heating element 2 is insulated from the pixel units 5 and the black matrix 4 by the protective layer 3. The protective layer 3 may be made of SiN or insulated resin.

In the present embodiment, the heating element may be a non-transparent heating element (see the components indicated by the sign 22 in FIG. 2) located in the non-light-transmission region. Preferably, the non-transparent heating element may be made of non-transparent metal or alloy. For example, a metal or alloy film layer may be formed by sputtering or depositing process, and a pattern of the non-transparent heating element 22 may be obtained by processing the film layer through a patterning process.

FIG. 2 illustrates the schematic top view of an exemplary arrangement of the non-transparent heating element 22 according to the present embodiment. As shown in FIG. 2, a plurality of strip-shaped non-transparent heating elements 22 are disposed in the non-light-transmission region of the color filter substrate, and they are in parallel with each other with intervals therebetween. The projections of the non-transparent heating elements 22 on the black matrix 4 are within the black matrix 4 so that the light transmission of the pixel units 5 will not be affected by the non-transparent heating elements 22. Preferably, the width of the non-transparent heating element 22 is less than 6 μm. Such width range can match the line width of the black matrix 4 in numerous types of liquid crystal display panel. For convenience of illustrating shapes of the strip-shaped non-transparent heating elements 22, the black matrix 4 is shown as being partially transparent, i.e., the strip-shaped non-transparent heating elements 22 can be seen, in FIG. 2. In fact, the non-transparent heating elements 22 are covered by the black matrix 4 and cannot be seen from the top.

### Embodiment 2

The present embodiment provides a liquid crystal display panel, which comprises an array substrate, the color filter substrate in the embodiment 1, and a liquid crystal layer disposed between the array substrate and the color filter substrate. As shown in FIG. 2, preferably, the liquid crystal display panel further comprises a first electrode 6 and a second electrode 7 disposed on opposite sides of the liquid crystal display panel respectively. The non-transparent heating elements 22 are electrically connected with the first electrode 6 and the second electrode 7 so as to be supplied with power to generate heat. Specifically, the first electrode 6 and the second electrode 7 may be disposed in the driving region (position corresponding to the border) of the liquid crystal display panel to avoid affecting the display of the pixel units 5.

Preferably, the width of the non-transparent heating element 22 is less than 6 μm. Such width range can match the line width of the black matrix 4 in numerous types of liquid crystal display panel.

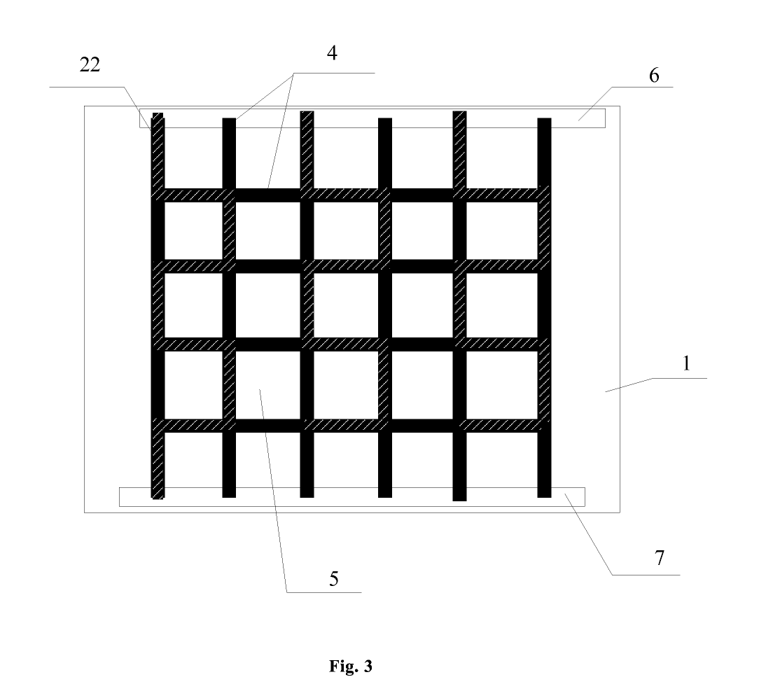

Preferably, as shown in FIG. 3, the non-transparent heating elements 22 may be formed as a zigzagged shape on the color filter substrate.

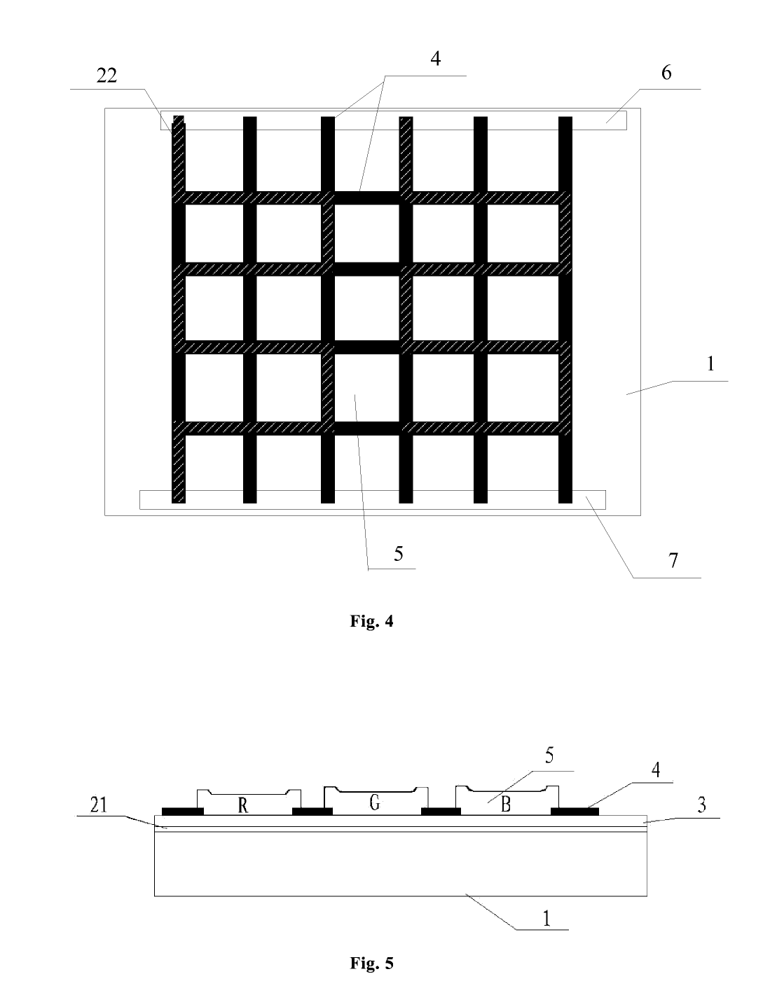

As shown in FIG. 4, the zigzagged shape of the non-transparent heating elements 22 may span more pixel units 5.

It can be understood that the non-transparent heating elements 22 may be formed as other shape, as long as they do not beyond the line width of the black matrix 4 and not affect the light transmission of the pixel units 5.

Preferably, a protective layer 3 (see FIG. 1) may be disposed on the side of the non-transparent heating elements 22 away from the substrate 1 so as to insulate the non-transparent heating elements 22 from the pixel units 5 and the black matrix 4. The protective layer 3 may be made of SiN or insulated resin.

### Embodiment 3

The present embodiment provides a liquid crystal display panel which is different from the liquid crystal display panel in the embodiment 2 in that a transparent heating element 21 is provided therein. Preferably, the transparent heating element 21 is made of transparent metal or alloy, such as Indium Tin Oxide (ITO).

The construction of the transparent heating element 21 may be the same as that of the non-transparent heating element 22 in the embodiment 2, e.g., the transparent heating element 21 may include a plurality of strip-shaped structures disposed in parallel with each other with intervals therebetween as shown in FIG. 2, or a strip-shaped zigzag pattern shown in FIG. 3 or 4, or any other suitable arrangement.

Furthermore, since the heating element in the present embodiment is the transparent heating element 21, the transparent heating element 21 may be arranged in more flexible manner. For example, as shown in FIG. 5, the transparent heating element 21 may be arranged as a whole layer, i.e., a layer of transparent heating element 21 may be arranged at the side of the substrate 1 close to the pixel units so as to cover the entire surface of the side. The transparent heating element 21 may be partially arranged in the light-transmission region. It should be pointed out that both of the transparent heating element 21 and the non-transparent heating element 22 may be arranged in the non-light-transmission region, as long as the normal display of the light-transmission region do not affected by the arrangement. Other manners for arranging the transparent heating element 21 will not be enumerated in detail here. Preferably, as shown in FIG. 5, a protective layer 3 may be provided at a side of the transparent heating element 21 away from the substrate 1 so as to insulate the transparent heating element 21 from the pixel units 5 and the black matrix 4. The protective layer 3 may be made of SiN or insulated resin.

### Embodiment 4

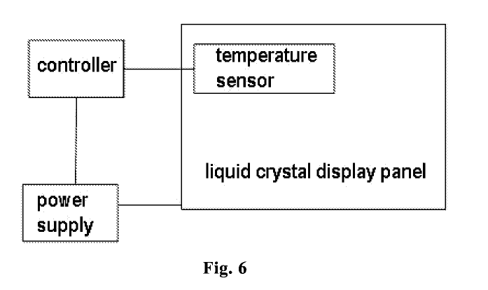

As shown in FIG. 6, the present embodiment provides a temperature control system for liquid crystal panel, which comprises a temperature sensor, a controller and a power supply.

The temperature sensor is used for detecting the temperature of the liquid crystal display panel, and transmitting a temperature signal to the controller. The temperature sensor may be disposed in the driving region of the liquid crystal display panel so as to avoid affecting the display of the pixel units. It can be understood that, if the temperature sensor employed has sufficiently small size, it may be disposed in a region corresponding to the black matrix to detecting the temperature of the liquid crystal cell with smaller distance from the liquid crystal cell.

The controller is electrically connected to the temperature sensor to receive the temperature signal transmitted by the temperature sensor, and determine whether the heating element in the liquid crystal display panel should be supplied with power or not based on the temperature signal. If the temperature of the liquid crystal display panel reaches the lower limit of the working temperature range for the liquid crystal, the controller determines that the heating element should be powered, and sends an instruction of supplying power to the power supply so as to heat the liquid crystal display panel until the temperature of the liquid crystal display panel reaches, for example, the upper limit of the working temperature range for the liquid crystal. It can be understood that, the temperature controlling range for the liquid crystal display panel may be set according to specific applications.

The power supply provides electric power to the heating element based on the instruction of supplying power to the heating element in the liquid crystal display panel sent by the controller. Specifically, the power supply is electrically connected to the non-transparent heating element or the transparent heating element. When receiving the instruction of supplying power sent by the controller, the power supply starts to provide electric power to the non-transparent heating element or the transparent heating element in the liquid crystal display panel.

The liquid crystal display panel in the present embodiment may be the liquid crystal display panel in the embodiment 2 or 3.

The temperature control system for liquid crystal panel in the present embodiment is capable of detecting the temperature of the liquid crystal display panel in real time. When the temperature of the liquid crystal display panel is too low and approaches to the critical temperature (e.g., the lower limit of the working temperature range of the liquid crystal) with which the displaying speed is affected, the heating element is powered so as to warm up the liquid crystal display panel, and once the temperature of the liquid crystal display panel reaches a temperature (e.g., room temperature) with which it can operate normally, the supplying of power to the heating element is stopped. In this way, it is ensured that the liquid crystal display panel is always in the normal displaying state.

### Embodiment 5

The present embodiment provides a liquid crystal display device which comprises the color filter substrate in the embodiment 1 or comprises the liquid crystal display panel in the embodiment 2 or 3.

Preferably, the liquid crystal display device further comprises the above temperature control system for liquid crystal panel in the embodiment 4.

The liquid crystal display device of the present embodiment is capable of detecting and controlling the temperature of the liquid crystal display panel in real time through the temperature control system. The temperature control system supplies power to the heating element to warm up the liquid crystal display panel when the liquid crystal display panel is at a lower temperature, and stops supplying power to the heating element once the temperature of the liquid crystal display panel reaches a suitable temperature with which it can operate normally, thus it is ensured that the liquid crystal display panel is always in the normal displaying state.

It can be understood that the above embodiments are only exemplary embodiments for illustrating the principle of the present invention; however, the present invention is not limited thereto. The liquid crystal display device may be any product or component with a displaying function, such as a mobile phone, a tablet computer, a television, a display, a notebook PC, a digital album, a navigator, and so on. The implementation of the liquid crystal display device may be referred to the forgoing embodiments, and the details will not be repeated again here. As for a skilled in the art, various variations and improvements can be made without departing from the spirit and essence of the present invention, and should be considered to be fallen within the protection scope of the present invention.

1. A color filter substrate, comprising a light-transmission region and a non-light-transmission region,
wherein a transparent heating element is provided in the light-transmission region and/or the non-light-transmission region; and/or
a non-transparent heating element is provided in the non-light-transmission region.

2. The color filter substrate of claim 1, wherein the transparent heating element is connected to a power supply component; and/or the non-transparent heating element is connected to the power supply component.

3. The color filter substrate of claim 1, wherein the transparent heating element is made of transparent metal or alloy, and the non-transparent heating element is made of non-transparent metal or alloy.

4. The color filter substrate of claim 1, wherein a projection of the non-transparent heating element on the non-transmission region is within the non-transmission region.

5. The color filter substrate of claim 1, wherein a width of the non-transparent heating element is smaller than 6 μm.

6. The color filter substrate of claim 1, wherein the non-transparent heating element or the transparent heating element is formed as a zigzag pattern on the color filter substrate.

7. The color filter substrate of claim 2, wherein the non-transparent heating element or the transparent heating element is formed as a zigzag pattern on the color filter substrate.

8. The liquid crystal display panel of claim 3, wherein the non-transparent heating element or the transparent heating element is formed as a zigzag pattern on the color filter substrate.

9. The liquid crystal display panel of claim 4, wherein the non-transparent heating element or the transparent heating element is formed as a zigzag pattern on the color filter substrate.

10. The liquid crystal display panel of claim 5, wherein the non-transparent heating element or the transparent heating element is formed as a zigzag pattern on the color filter substrate.

11. The liquid crystal display panel of claim 1, wherein a protective layer is provided at a side, which is distant away from a substrate of the color filter substrate, of the non-transparent heating element or the transparent heating element.

12. The liquid crystal display panel of claim 2, wherein a protective layer is provided at a side, which is distant away from a substrate of the color filter substrate, of the non-transparent heating element or the transparent heating element.

13. The liquid crystal display panel of claim 3, wherein a protective layer is provided at a side, which is distant away from a substrate of the color filter substrate, of the non-transparent heating element or the transparent heating element.

14. The liquid crystal display panel of claim 4, wherein a protective layer is provided at a side, which is distant away from a substrate of the color filter substrate, of the non-transparent heating element or the transparent heating element.

15. The liquid crystal display panel of claim 5, wherein a protective layer is provided at a side, which is distant away from a substrate of the color filter substrate, of the non-transparent heating element or the transparent heating element.

16. A liquid crystal display panel, comprising an array substrate, the color filter substrate of claim 1 and a liquid crystal layer disposed between the array substrate and the color filter substrate, wherein the liquid crystal display panel further comprises a first electrode and a second electrode which are disposed on opposite sides of the liquid crystal display panel respectively, the non-transparent heating element or the transparent heating element being electrically connected with the first electrode and the second electrode.

17. The liquid crystal display panel of claim 16, wherein a projection of the non-transparent heating element on the non-transmission region is within the non-transmission region.

18. The liquid crystal display panel of claim 16, wherein the non-transparent heating element or the transparent heating element is formed as a zigzag pattern on the color filter substrate.

19. The liquid crystal display panel of claim 16, wherein a protective layer is provided at a side, which is distant away from a substrate of the color filter substrate, of the non-transparent heating element or the transparent heating element.

20. A liquid crystal display device, comprising the color filter substrate of claim 1.
